(19) United States
(12) Patent Application Publication
(10) Pub. No.: US 2006/0136406 A1
(43) Pub. Date: Jun. 22, 2006

(54) Spatial search and selection feature

(76) Inventor: Erika Reponen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 11/016,157

(22) Filed: Dec. 17, 2004

(51) Int. Cl. G06F 17/30; G06F 7/00

(52) U.S. Cl. 707/4

(57) ABSTRACT

The invention relates to a method for searching content from a computer storage means by means of a visual user interface. The search is carried out by a search command, and search results that can be more than one, are displayed in their actual locations in said user interface. The invention also relates to a device, to a displaying unit and to a computer program product.

### FIELD OF THE INVENTION

This invention relates to a search in computer systems and particularly to such a search that is carried out in a spatial user interface.

### BACKGROUND OF THE INVENTION

Spatial interfaces that can be two-dimensional or three dimensional, are known in related art. In such an interface one or many document files or other items can be seen in their specific locations. One typical example of a spatial interface is the Windows™ desktop.

Document files can be searched from a computer system by defining search criteria (name, piece of text, file type) as well as the folders (and subfolders) being searched. The search criteria is input to a specific search window. Normally, the search action is carried out by going through the specified folders and presenting search results in real time in a result window that can replace the search window, when the search is started. The search and result window are independent of the other user interface windows and usually only used for the search and the results. The result window gathers the results (the hits) and presents them to the user. The result is presented to the user as a link and by selecting said link the resulted document file is opened from its actual location. It is noticed that in this kind of solution the search result is shown within other search results irrespective of their actual locations. The search results are drawn from their context and surroundings, which may affect the user's perceptivity of the actual structure of stored document files.

Therefore a more metaphoric search method is needed, which takes into account the visualization of the search targets and search results. Such a method, which utilizes user's perceptivity of context, is considered a great improvement over the methods of the related art. This invention addresses such a need and such an improvement.

### SUMMARY OF THE INVENTION

The present invention provides a new method for searching and showing search results in a spatial user interface. In the method the search is targeted to real locations of the content shown on the screen.

The method for searching content in a spatial user interface according to one example of the invention comprises steps for defining at least one search target in the spatial user interface for the search, for which at least one target of the search is done, whereby after at least one result for the content is found, at least one result item containing the searched content is highlighted on the user interface.

A device according to one example of the invention comprises a search robot for searching content in a spatial user interface displayed by a displaying means to which displaying means the device is connected to, said device further comprising means for defining at least one search target in the spatial user interface for which search target the search robot is configured to make the search, whereby after at least one result for the content is found, the device is capable of highlighting on the user interface at least one result item containing the searched content.

A computer program product for searching content in a spatial user interface, comprises computer readable instructions stored on a readable medium for execution by a processor, the computer readable instructions for defining at least one search target in the spatial user interface for which search target the computer program product is capable of making the search, and so that after at least one result for the content is found, the computer program product comprises instructions for highlighting on the user interface at least one result item containing the searched content.

The invention has considerable advantages compared to the solutions of related art. The invention enables spatial searches in various user interfaces and devices. The search is made and visualized in the user interface's content view itself. The search is viewable in contrast to related art where the search is made as a background operation. When using the spatial selection/search feature according to the invention, the user is constantly aware of what happens, where the selection/search is currently carried out and from where the searched content is found. In addition, the search command can be made spatially by pointing to the desired place in the screen.

For some people visual memory may be more dominant than other sensory memories. For those people, it may be easier to remember where content is stored using spatial location than to remember content in a treelike hierarchy.

### DESCRIPTION OF THE DRAWINGS

The preferred embodiment of the invention is set forth in the drawings, in the detailed description which follows, and in the claims annexed to. Further objects and advantages of the invention are also considered in the description. The invention itself is defined with particularity in the claims.

FIG. 1 illustrates in a very simplified manner an example of the user interface with one search result according to the invention,

FIG. 2 illustrates in a very simplified manner another example of the user interface with one search result according to the invention,

FIG. 3 illustrates in a very simplified manner yet another example of the user interface with many search results according to the invention,

FIG. 4 illustrates in a more detailed manner an example of the user interface with many search results according to the invention,

FIGS. 5a-d illustrate examples of the user interface relating to the searching method, and

FIG. 6 illustrates a very simplified example of the device operating with the searching method.

### DETAILED DESCRIPTION OF THE INVENTION

In the description term “search cursor” is used to describe a cursor that operates as a selection cursor and/or a search cursor. The cursor can be a separate user interface element or it can be an effect that highlights the item that is selected. The selection cursor and the search cursor can be different kinds of user interface elements. Also in the description, the term “search bar” is used to describe a bar that operates as a selection bar and/or a search bar. The selection bar and the search bar can be different kinds of user interface elements. In the description, the term “content” is used to describe the searchable information. The content may be singular, as a document, a file, a mark, or the content may be part of broader content, such as a piece of text, an author of a file, updating time, file type etc. The term “item” refers to an indicative visual element on the user interface that comprises content that is some searchable information. Term “result item”, on the other hand, refers to such an indicative visual element on the user interface that comprises the information being searched. The item and the result item can be a directory icon, a file icon, a partial or a whole user interface view or similar.

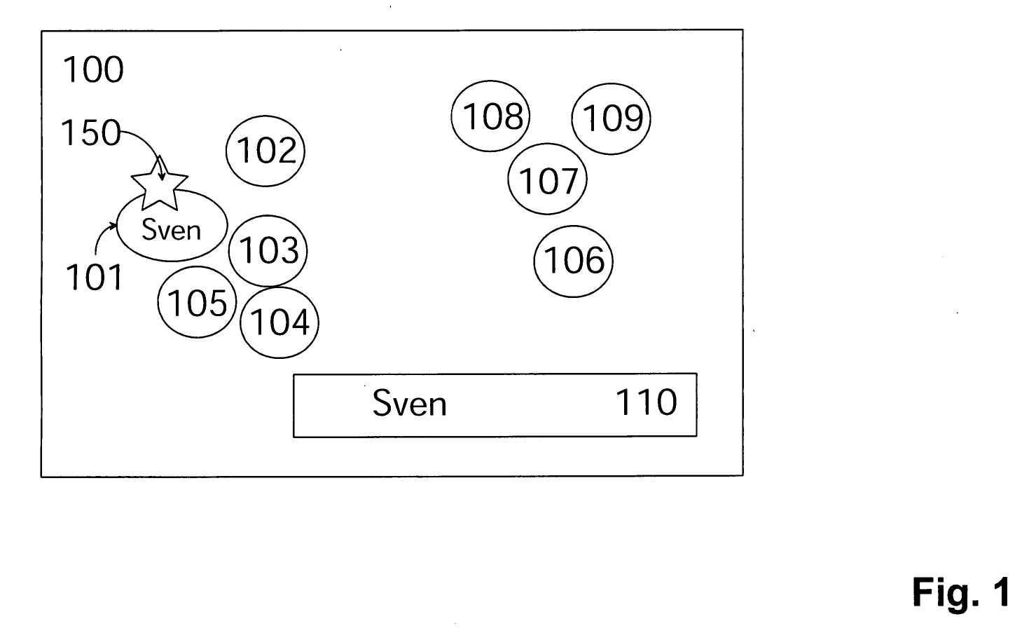

The basic user interface structure according to the invention is illustrated in FIG. 1. The user interface 100 comprises a search cursor 150 that operates as a selection cursor, when the user starts the search. The user interface may comprise also a search bar 110 that shows the information about the search results and that acts also as an input bar if the search cursor 150 is used for some other actions and the search should be made with search terms that need some kind of input like typing or selecting the terms of the search. There are also several items 101, 102, 103, 104, 105, 106, 107, 108, 109 on the user interface and it will be appreciated that the number of items can vary depending on the situation. Similarly it will be appreciated that the items do not necessarily need to be similar items, e.g. of the same type.

For starting the search the user uses the search cursor 150 to select a place on the user interface 100 where the search is targeted or wherefrom the search is started. The place can comprise a singular item or a group of items. The search cursor 150 can be configured to move on the user interface while the search is made, i.e. during the search action. The search cursor 150 can show the item or items, which the search is focused at the moment. It should be noticed that the search action could also be made on the background if the user so desires. In some situation, the user may work with other interface windows and applications at the same time, when the search is on action. In the FIG. 1 the user has defined a search target and the search cursor 150 indicates the result item 101 and the information about that item “Sven” is shown in the search bar 110.

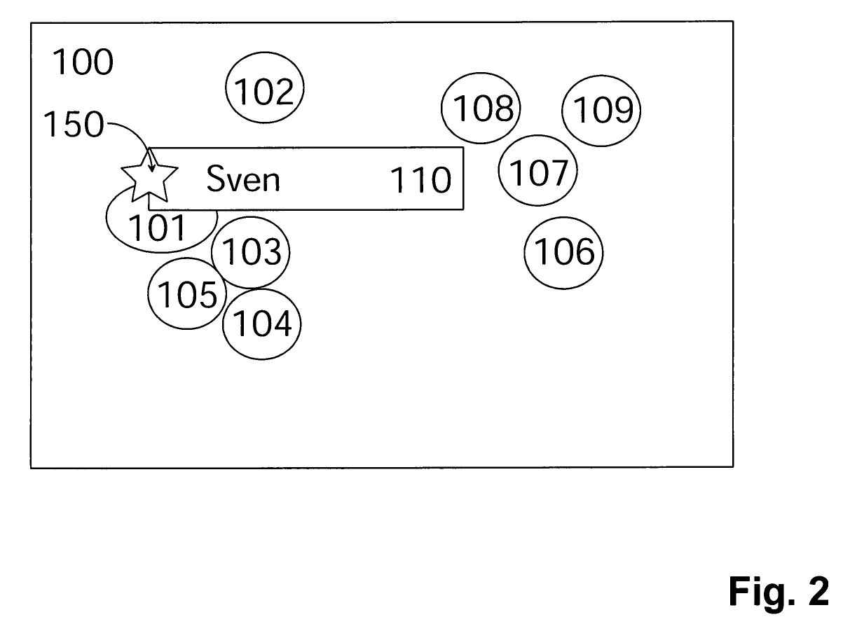

In FIG. 2 the search element is a combination of the search cursor 150 and the search bar 110. In the situation of FIG. 2, the user has defined a search target and the search cursor 150 indicates the result item with the search bar 110 showing the information about that item “Sven”. In this example the search cursor 150 and search bar 110 are moving together during the search.

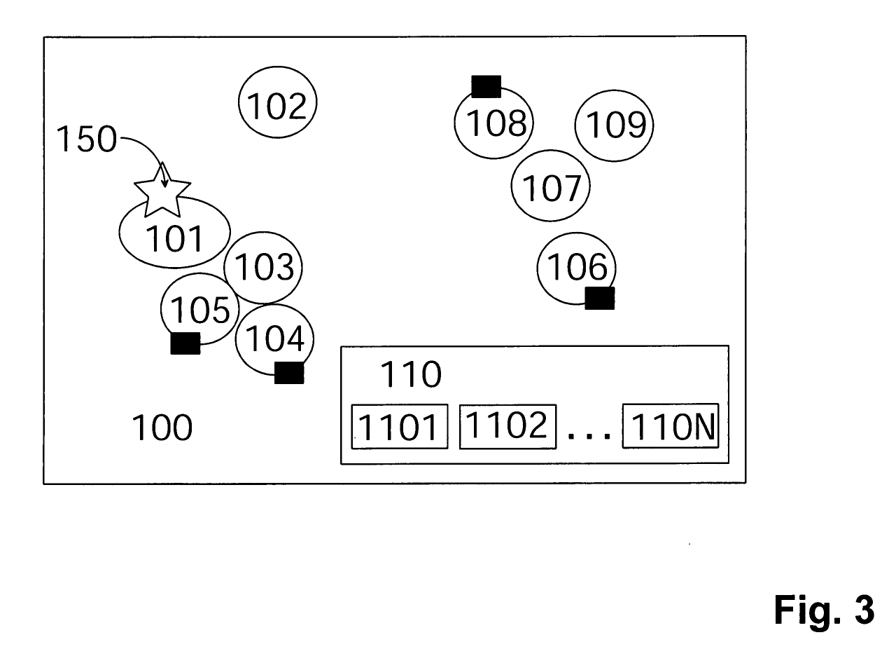

The actual search action and the result item are displayed visually on the user interface 100. The search action and the result item are presented with the search cursor 150 and with other elements presenting found search results by appearing into the locations where the searched content was found. This kind of example is illustrated in FIG. 3, where black boxes connected to items 104, 105, 106, 108 illustrate the results found from those items.

While searching the search cursor 150 leaves visual marks (black boxes in FIG. 3) on the places where searched content was found. If the wanted content is found from one location only, the search cursor 150 itself can indicate the location (example in FIG. 1) and any other visualization is not necessarily needed. A result mark can be an autonomic object that is added to the visualization of the result item, or some other feature, e.g. a frame that is added to each result item where the searched content locates or a searched content is shown or highlighted in a more detailed way in connection to the result item.

The search bar 110 can show the terms (if there are such) of the search and the result(s) after (in some situations during) the search. The search bar 110 is an optional element and in additional to search cursor 150, it can operate even though the search cursor 150 is leaving marks to each result item location. The search bar 110 can be located in a specific place on the user interface or it can be a floating element (as in FIG. 2). The search bar 110 can also be connected to the search cursor 150 (as in FIG. 2). It should be noticed from FIG. 3 that the search bar 110 may comprises more than one field. In this FIG. 3, the search bar 110 comprises many fields 1101, 1102, 110N. The fields 1101, 1102, 110N may all be configured to input only or to results only, but the fields 1101, 1102, 110N may be divided between input and results, so that part of the fields is used for input and part of the fields is used for results. This enables presenting of search commands and results at the same time even though it is not obliged to do so. The search bar can, in some situations, locate outside the window where the search is made.

In the example of FIG. 3 the user may input a search criteria to input field 1101 of the search bar 110. After inputting the search is started and the search cursor 150 moves around the user interface view. The search cursor 150 goes through all the items and marks with black squares the result item locations where the wanted (input) search term is found. After the search, the user may select all the marked result items or one or some of them. The user may also continue with new searches. It is possible to have several searches running on the user interface at the same time, whereby the results of different searches can be shown to the user as different elements in connection with the result item(s) in question.

The method according to the invention is applicable in two dimensional as well as in three dimensional user interfaces. There can also be other dimensions, such as time. Item(s) can be visible on the screen but it is also possible that all the items are not visible all the time. In both cases, the search method according to the invention can be used. For example some item(s) can cover some other item(s), whereby they cannot be seen, but these item(s) can be thought of as visible item(s) since they would be visible for the viewer if there was not the other item(s) between them and the viewer. In addition, the item(s) can be, for example, so far that it seems invisible in that certain view but it would be visible if it is viewed from some other place. Also it may be possible to make applications that remember the usual location of the item(s) and can utilize that fact in the search, although the item is not located at that place at the moment.

The user interface according to the invention comprises the aforementioned elements, such as the search cursor and the search bar. The elements are applicable in different user interface types as well as displays. The search elements can be used for example with touch screen pen, joystick as well as with arrow keys. There is also some kind of visualization of the content needed on the display.

The search method according to the invention is possible to carry out in different ways. The following embodiments are examples of the possible use cases.

In the first embodiment the user starts the search by pointing the wanted place in the user interface with a search cursor, which acts as a selection element for this operation. The place in the user interface shows or includes the content, where the search is targeted. When the search is completed on the place, the result is shown in the search bar by text or by other visual elements. If the content is not found in the pointed place, the user can broaden the search with another definition, whereby the next search result is shown in the search bar. The next result is the next closed element in the user interface space. This continues until the searched content is found or until all the possible places are searched. The first embodiment is advantageous when the user has an idea of the location of the searched content in the user interface space or when the user recognizes the searched content from the user interface space by its visual appearance. If the user points to a slightly wrong place, but near the place he/she meant, it is easy to find the searched content by going on in the search action like that explained above, meaning that the search cursor moves to places where it is searching and at the same time the results of the search is shown to the user in the search bar.

In the second embodiment, the user starts the search by marking a desired area in the user interface, which desired area is used as a search target. The desired area can be e.g. a certain directory or e.g. one or many item(s) on the user interface. The marking can be done e.g. by drawing a circle or square around the wanted area or wanted items. The search action is visually shown with the search cursor that moves in the defined area. All the search results that are found from the selected area are shown in the search bar. If the selected area does not include the content that user was searching or the user wants to broaden the search, it is possible to mark a broader area. The user can broaden the marked area or the search can continue outside the marked area so that the next search result is the next closest item in user interface space after the selected area. The searching proceeds as long as the searched content is found or all the possible items are searched.

In the third embodiment the search is started by the user using some known method, e.g. by typing search criteria to the search bar or by selecting wanted search attributes. The starting can also be made by means of some other way. However, even though the search is started in a known manner, the search action and results are shown according to the invention, i.e. where the content is located (and not necessarily in a specific result window). The search cursor moving in the content inside which the search is made, is shown to the user. The search action is visualized with the movement of the search cursor on the user interface space. The user is able to see in which part of the user interface (or the application or the page or the network or similar) the search is made and in which order. Also the result items are visual so that the user can see in which location the searched content was found. For example, if the user knows a certain location in displayed user interface space where a specific content is contained, the user can make the selection in the group of search results based on that.

In the fourth embodiment, starting of the search has two separate parts. The search is started and partly made by the user making the search command with input to the search bar presented in this invention or using some known method to make the search, e.g. by typing the search criteria. In addition the search command is partly made by selecting the location in the visual user interface, e.g. by pointing or selecting an area. The search cursor moves on the user interface like in the other embodiments but only in the part of the user interface space the user has selected and in terms of the other input that was given by the user. Search action and results are visualized spatially, similar to other embodiments, and also in the search bar.

In the fifth embodiment the user points the location where the search is desired to be started. This embodiment is similar to the first embodiment, but broadening the search is in this embodiment made automatically. The user is capable of stopping the search whenever that is wanted.

In some situation the user may need to change the search target dynamically while the search is still running. In that case the already found results can remain visible if desired and the cursor is moved to another search target. It is also possible to remove the already found results, when the new search is started. This can happen in a situation, where the first search target was completely incorrect.

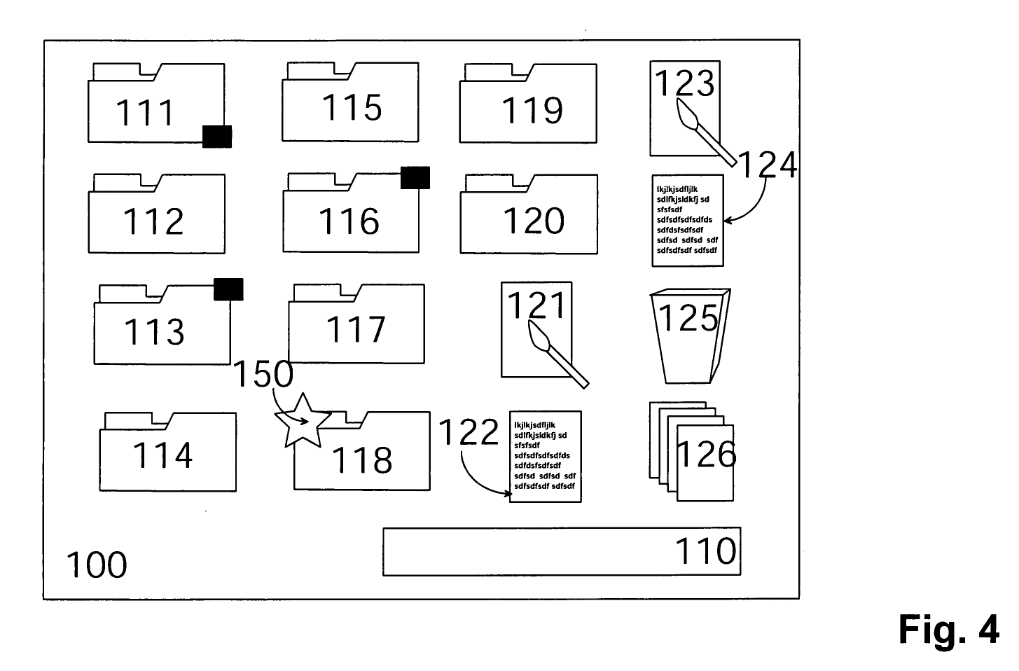

Yet one example of the user interface 100 is illustrated in FIG. 4, which presents the utilization of the method according to the invention in relation to a listed file view. The files 111-126 on the user interface 100 are searched and the search cursor 150 goes through said files. When searched content is found, the search cursor 150 marks the result items 111, 113, 116.

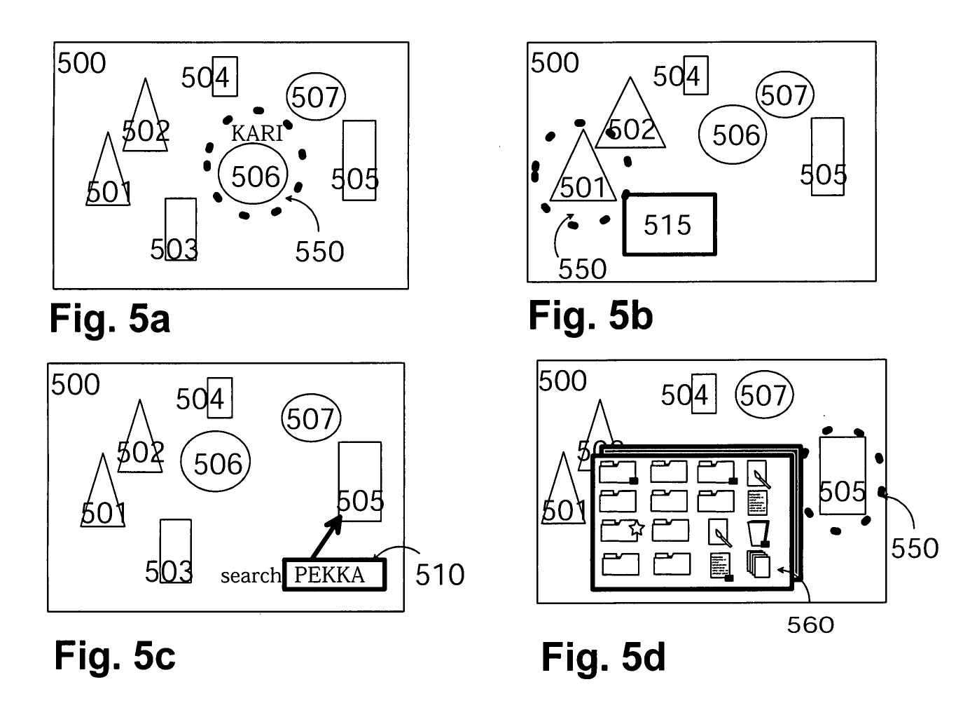

A few examples of the user interface 500 are illustrated in FIGS. 5a-5d. The user interface described here is a multi-user interface, where the users are identifiable by certain user interface elements (item(s)). Also with this kind of arrangement the search method is applicable. The search method can be used for determining (FIG. 5a) who a certain element 506 relates to, e.g. by highlighting or pointing 550 the element 506. The result “KARI” is shown on the user interface 500. Also it is possible to determine (FIG. 5b) which content is held by some certain element. The user may point the element 501 and search the content of it, whereby the user interface provides the content 515, e.g. an image. If the user is aware of the location of a certain user (FIG. 5c), the user may target the search to known location 505 and define the searchable element “PEKKA” into search bar 510. Yet, it is possible to determine where are, e.g., files of the school workshop (FIG. 5d). The search criteria “school workshop” is typed into search bar and the search goes through the user interface 500. When the files 560 are found, they are shown to the user.

The user interface view in the invention can be scalable, zoomable or changeable in some other way. The user interface should be made in a way that the user is always aware (or knows how to become aware) of the location, where the user is in the user interface space. Also the visualization of other dimensions and places of the user interface space is important for indicating the user where certain contents are. The user interface is updateable, and therefore it is not limited to the elements described earlier, but can include other elements as well.

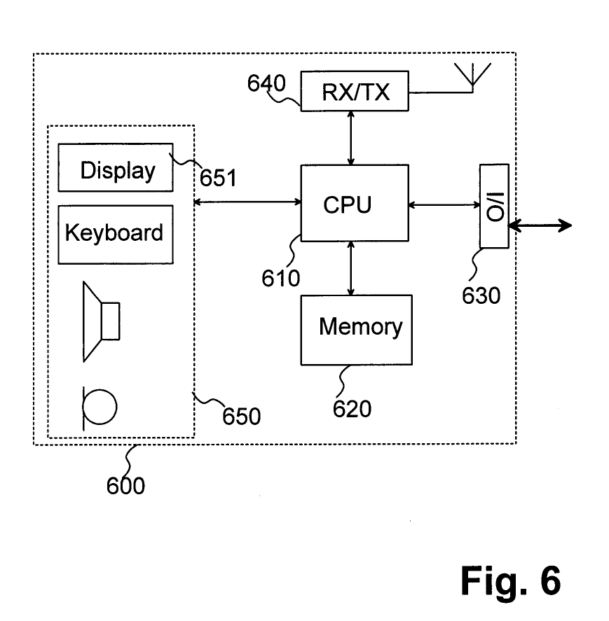

The device 600 operating with the search method is illustrated in FIG. 6 in very simplified manner. The device 600 comprises at least a display 651 for presenting the user interface and the search therein. The device 600 can comprise also other interaction means 650, such as keyboard and audio means. The device 600 comprises a processing unit 610 as well as a memory 620 for a storage. Further the device 600 comprises inputting/outputting means 630. The device 600 can also comprise other means depending on the nature of the device. If the device 600 is a communication device, the device can comprise needed communication means, such as a receiver/transmitter 640 or networking capabilities. The processing unit 610 of the device 600 comprises a search robot or similar for carrying out the search. The search robot receives search commands and definitions, such as search criteria, location on the user interface etc. While the search robot is carrying out the search it controls the search cursor according to the search, so that the search cursor is capable of going through the items visually. The device 600 can comprise the display and other means as embedded elements on the device itself (e.g. mobile terminal), but it is also possible to form the device as a combination of singular electronic components, which are connected to each other in some known manner (e.g. personal computer).

The searchable content can be a file, document, part of a document (e.g. piece of a text), a computer or a network node. The method can be applied to databases (contact database, image database, video or music database, any combination of databases), when the database is presented to a visualized user interface. The searched and shown content can be situated in the user's device or in some other device that is reached by means of a communication network.

One skilled in the art will appreciate that the invention may incorporate any number of capabilities and functionalities, which suitably enhance the efficiency of the search. The invention has been described by means of particular examples and it should be noticed that any combination of the presented examples and embodiments could apply the method according to the invention. Additionally, the invention may provide other manual or automatic operations for managing inquiries and requests and maintaining data. Additionally, one skilled in the art will appreciate that numerous databases and systems may suitably communicate with the present system in order to provide enhanced functionality.

What is claimed is:

1. A method for searching content in a spatial user interface, wherein
at least one search target in the spatial user interface is defined for the search, for which at least one target of the search is done, so that after at least one result for the content is found
at least one result item containing the searched content is highlighted on the user interface.

2. The method according to claim 1, wherein the search action is displayed dynamically by a search cursor moving from a searched item to the next unsearched item until the search is completed.

3. The method according to claim 1, wherein each result item is highlighted in its actual location in the user interface.

4. The method according to claim 3, wherein each result item is highlighted by a visual element.

5. The method according to claim 1, wherein a search target is defined by marking a search area in the user interface.

6. The method according to claim 5, wherein the search target is defined by pointing to the target in the user interface.

7. The method according to claim 5, wherein the search target is defined by typing the target into a search bar in the user interface.

8. A device comprising a search robot for searching content in a spatial user interface displayed by a displaying means to which displaying means the device is connected, said device further comprising means for defining at least one search target in the spatial user interface for which search target the search robot is configured to make the search, so that after at least one result for the content is found, the device is capable of highlighting on the user interface at least one result item containing the searched content.

9. The device according to claim 8, wherein the device is configured to show the movement of a search cursor during search action from a searched item to a next unsearched item until the search is completed.

10. The device according to claim 8, wherein the device is configured to highlight each result item in its actual location in the user interface.

11. The device according to claim 10, wherein the device is configured to highlight the result item by means of a visual element.

12. The device according to claim 8, wherein the user interface further comprises a search bar comprising one or more fields for inputting search command and outputting results.

13. The device according to claim 8, comprising the displaying means.

14. The device according to claim 8, further comprising communication means.

15. A computer program product for searching content in a spatial user interface, said computer program product comprising computer readable instructions stored on a readable medium and for execution on a processor, the computer readable instructions instructions for defining at least one search target in the spatial user interface for which search target the computer program product is capable of making the search, and so that after at least one result for the content is found, the computer program product comprises instructions for highlighting on the user interface at least one result item containing the searched content.

16. The computer program product according to claim 15, further comprising computer readable instructions for showing search action dynamically by controlling a search cursor to move from a searched item to a next unsearched item until the search is completed.

17. The computer program product according to claim 15, being arranged into a device from the following group: a mobile terminal, a communicator, a personal computer, and a laptop.
